(19) United States
(12) Patent Application Publication
(10) Pub. No.: US 2024/0340348 A1
(43) Pub. Date: Oct. 10, 2024

(54) METHOD AND APPARATUS FOR DETERMINING RESOURCE LOCATION, TERMINAL, AND NETWORK DEVICE

(71) Applicant: SPREADTRUM SEMICONDUCTOR (NANJING) CO., LTD., Nanjing, Jiangsu (CN)

(72) Inventors: Zhenzhu LEI, Nanjing, Jiangsu (CN); Huayu ZHOU, Nanjing, Jiangsu (CN)

(21) Appl. No.: 18/579,398

(22) PCT Filed: Jul. 14, 2022
(86) PCT No.: PCT/CN2022/105823

§ 371 Date: Jan. 15, 2024

(30) Foreign Application Priority Data
Jul. 15, 2021 (CN) 202110804355.6

(51) Int. Cl. H04L 67/145; H04L 5/00; H04W 52/02; H04W 68/00

(52) U.S. Cl. CPC H04L 67/145; H04L 5/0007; H04W 52/0235; H04W 68/005

(57) ABSTRACT

A method and apparatus for determining a resource location, a terminal, and a network device are provided. The method includes the following. A network device sends configuration information. A terminal obtains the configuration information. The terminal determines a first resource location according to the configuration information, where the first resource location is used for the terminal in a first state to monitor a first wake-up signal (WUS), and the first WUS is used for triggering transition of the terminal to a second state from the first state. Since the configuration information is used for determining the first resource location, it is possible to determine, based on the configuration information, a resource location used for monitoring the first WUS in the first state, thereby ensuring robustness and stability of system communication while reducing network overhead and power consumption of the terminal.

### CROSS-REFERENCE TO RELATED APPLICATION(S)

This application is a National Stage of International Application No. PCT/CN2022/105823, field Jul. 14, 2022, which claims priority to Chinese Patent Application No. 2021108043556, filed Jul. 15, 2021, the entire disclosures of which are hereby incorporated by reference.

### TECHNICAL FIELD

This disclosure relates to the field of communication technology, and more particularly, to a method and apparatus for determining a resource location, a terminal, and a network device.

### BACKGROUND

If a terminal is in a radio resource control (RRC) idle (RRC_IDLE) state or an RRC inactive (RRC_INACTIVE) state, the terminal may determine, according to an indication of a wake-up signal (WUS), whether to monitor a paging occasion (PO) corresponding to the WUS, which can prevent the terminal from always monitoring a PO in a paging cycle, thereby reducing power consumption of the terminal.

However, with continuous evolution of standard protocols formulated by the 3^{rd} generation partnership project (3GPP) and continuous increase in complexity of communication scenarios, to prolong the battery life of the terminal to a duration of several weeks or even several years, 3GPP is currently discussing issues related to introducing a new WUS (for example, a low-power WUS), as well as scenarios of using the new WUS to wake up the terminal in a non-RRC_IDLE state or in a non-RRC_INACTIVE state so as to reduce power consumption. To this end, the problem regarding transmission resource configuration for the new WUS and how the terminal receives the new WUS needs further study.

### SUMMARY

In a first aspect, a method for determining a resource location is provided in the disclosure. The method includes the following. A terminal obtains configuration information. The terminal determines a first resource location according to the configuration information, where the first resource location is used for the terminal in a first state to monitor a first WUS, and the first WUS is used for triggering transition of the terminal to a second state from the first state.

In a second aspect, a terminal is provided in the disclosure. The terminal includes a processor, a memory, a communication interface, and at least one program. The at least one program is stored in the memory and configured to be executed by the processor. The at least one program includes instructions for implementing the steps in the first aspect of the disclosure.

In a third aspect, a non-transitory computer-readable storage medium is provided in the disclosure. The computer-readable storage medium is configured to store computer programs and data for electronic data interchange (EDI). The computer programs and data are operable with a computer to implement some or all of the steps described in the first aspect or the second aspect of the disclosure.

### BRIEF DESCRIPTION OF THE DRAWINGS

In order to describe more clearly technical solutions of embodiments of the disclosure, the following will give a brief introduction to the accompanying drawings used for describing the embodiments or the related art.

FIG. 1 is a schematic architectural diagram of a wireless communication system provided in embodiments of the disclosure.

FIG. 2 is a schematic flowchart of a method for determining a resource location provided in embodiments of the disclosure.

FIG. 3 is a schematic structural diagram illustrating a first resource location provided in embodiments of the disclosure.

FIG. 4 is a schematic structural diagram illustrating another first resource location provided in embodiments of the disclosure.

FIG. 5 is a block diagram illustrating functional units of an apparatus for determining a resource location provided in embodiments of the disclosure.

FIG. 6 is a block diagram illustrating functional units of another apparatus for determining a resource location provided in embodiments of the disclosure.

FIG. 7 is a schematic structural diagram of a terminal provided in embodiments of the disclosure.

FIG. 8 is a schematic structural diagram of a network device provided in embodiments of the disclosure.

### DETAILED DESCRIPTION

In order for those skilled in the art to better understand technical solutions of the disclosure, technical solutions of embodiments of the disclosure will be described below with reference to the accompanying drawings in the embodiments of the disclosure. Apparently, the embodiments described herein are merely some embodiments of the disclosure, rather than all embodiments of the disclosure. Based on the embodiments of the disclosure, all other embodiments obtained by those of ordinary skill in the art without creative effort shall fall within the protection scope of the disclosure.

The terms “first”, “second”, and the like in the specification and claims of the disclosure, and above accompanying drawings are used to distinguish different objects, rather than describe a particular order. In addition, the terms “include”, “comprise”, and “have” as well as variations thereof are intended to cover non-exclusive inclusion. For example, a process, method, software, product, or device including a series of steps or units is not limited to the listed steps or units, and instead, it can optionally include other steps or units that are not listed or other steps or units inherent to the process, method, product, or device.

The term “embodiment” referred to in embodiments of the disclosure means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

It should be noted that, the terms “connection” appearing in the embodiments of the disclosure refers to various connection manners, such as direct connection or indirect connection, so as to implement communication between devices, which is not limited herein. The terms “network” and “system” in the embodiments of the disclosure refer to the same concept, and a communication system is a communication network.

The technical solutions of the embodiments of the disclosure may be applied to various wireless communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication System (UMTS), a wireless local area network (WLAN), a wireless fidelity (WiFi), a 6^{th}-generation (6G) communication system, or other communication systems.

It should be noted that, a conventional wireless communication system generally supports a limited quantity of connections and therefore is easy to implement. However, with development of communication technology, a wireless communication system will not only support a conventional wireless communication system but also support, for example, device to device (D2D) communication, machine to machine (M2M) communication, machine type communication (MTC), vehicle to vehicle (V2V) communication, vehicle to everything (V2X) communication, narrowband internet of things (NB-IoT) communication, etc. Therefore, the technical solutions of the embodiments of the disclosure can also be applied to these wireless communication systems.

Optionally, the wireless communication system in the embodiments of the disclosure may be applied to a beamforming scenario, a carrier aggregation (CA) scenario, a dual connectivity (DC) scenario, or a standalone (SA) deployment scenario, etc.

Optionally, the wireless communication system in the embodiments of the disclosure may be applied to an unlicensed spectrum, where the unlicensed spectrum may also be considered as a shared spectrum. Alternatively, the wireless communication system in the embodiments may be applied to a licensed spectrum, where the licensed spectrum may also be considered as a non-shared spectrum.

Since various embodiments of the disclosure are described in connection with a terminal and a network device, the terminal and the network device involved will be described in detail below.

Specifically, the terminal may be a user equipment (UE), a remote UE, a relay UE, an access terminal, a subscriber unit, a subscriber station, a mobile station, a remote station, a mobile device, a user terminal, a smart terminal, a wireless communication device, a user agent, or a user apparatus. It should be noted that, a relay device is a terminal capable of providing a relay forwarding service for other terminals (including a remote terminal). In addition, the terminal may also be a cellular radio telephone, a cordless telephone, a session initiation protocol (SIP) telephone, a wireless local loop (WLL) station, a personal digital assistant (PDA), various devices having wireless communication functions such as a handheld device, a computing device or other processing devices coupled with a wireless modem, an in-vehicle device, a wearable device, a terminal in a next-generation communication system (such as an NR communication system, a 6G communication system), or a terminal in a future evolved public land mobile network (PLMN), etc., which is not limited herein.

In addition, the terminal may be deployed on land, which includes indoor or outdoor, handheld, wearable, or in-vehicle. The terminal may also be deployed on water (such as ships, etc.). The terminal may also be deployed in the air (such as airplanes, balloons, satellites, etc.).

In addition, the terminal may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

Specifically, the network device may be a device for communicating with the terminal, and is responsible for radio resource management (RRM), quality of service (QoS) management, data compression and encryption, and data transmission and reception at an air-interface side. The network device may be a base station (BS) in a communication system or a device deployed on a radio access network (RAN) for providing wireless communication functions, for example, a base transceiver station (BTS) in a GSM or CDMA communication system, a node B (NB) in a WCDMA communication system, and an evolutional node B (eNB or eNodeB) in an LTE communication system, a next generation evolved node B (ng-eNB) in an NR communication system, a next generation node B (gNB) in an NR communication system, a master node (MN) in a DC architecture, a secondary node (SN) in a DC architecture, etc, which is not limited herein.

In addition, the network device may also be other devices in a core network (CN), such as an access and mobility management function (AMF), a user plane function (UPF), etc., or may be an access point (AP) in a WLAN, a relay station, a communication device in a future evolved PLMN, a communication device in an NTN network, etc.

In addition, the network device may include an apparatus, such as a system-on-chip (SOC), that has functions of providing wireless communication for the terminal. Exemplarily, the SOC may include a chip, and may further include other discrete devices.

In addition, the network device may communicate with an internet protocol (IP) network, for example, the Internet, a private IP network, or other data networks.

It should be noted that, in some network deployments, the network device may be an independent node so as to implement all functions of the base station, and may include a centralized unit (CU) and a distributed unit (DU), such as a gNB-CU and a gNB-DU. The network device may further include an active antenna unit (AAU). The CU can implement some functions of the network device, and the DU can also implement some other functions of the network device. For example, the CU is responsible for processing non-real-time protocols and services, and implements functions of a radio resource control (RRC) layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a media access control (MAC) layer, and functions of a PHY layer. In addition, the AAU can implement some PHY layer processing functions, radio frequency processing functions, and active-antenna related functions. Since RRC layer information will eventually become PHY layer information, or be transformed from PHY layer information, in such network deployment, it may be considered that higher layer signaling, such as RRC layer signaling, is transmitted by the DU, or transmitted by the DU and the AAU. It can be understood that, the network device may include at least one of the CU, the DU, or the AAU. In addition, the CU may be categorized into a network device in a RAN, or may be categorized into a network device in a CN, and the disclosure is not limited in this regard.

In addition, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In addition, the network device may serve a cell, and the terminal may communicate with the network device over a transmission resource (for example, a frequency-domain resource or a spectrum resource) for the cell. The cell may include a macro cell, a small cell, a metro cell, a micro cell, a pico cell, and a femto cell, etc.

With reference to the foregoing elaborations, a wireless communication system in embodiments of the disclosure will be exemplified below.

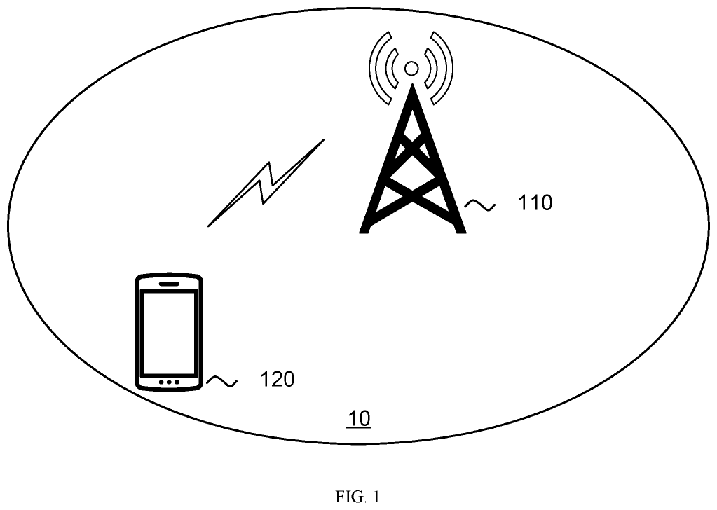

As illustrated in FIG. 1, the wireless communication system 10 may include a network device 110 and a terminal 120. The network device 110 may be a device for communicating with the terminal 120. In addition, the network device 110 may provide communication coverage for a specific geographical area, and may communicate with the terminal(s) 120 within the coverage area.

Optionally, the wireless communication system 10 may include multiple network devices, and there may be some quantity of terminals in a coverage area of each of the network devices, which is not limited herein.

Optionally, the wireless communication system 10 may further include other network entities such as a network controller and a mobility management entity, which is not limited herein.

Optionally, in the wireless communication system 10, communication between the network device and the terminal and communication between the terminals each may be wireless communication or wired communication, which is not limited herein.

Related contents involved in technical solutions of embodiments of the disclosure will be introduced below.

### 1. Paging

In a paging procedure, the network device sends a paging message to the terminal at a specific time, to notify the terminal to perform corresponding operations or update related parameters. The terminal in an RRC_CONNECTED state can determine, by decoding the paging message, whether a current system message has changed. If the terminal detects that the system message has been changed, the terminal will re-interpret the system message. The terminal in an RRC_IDLE state or in an RRC_INACTIVE state can know not only whether the current system message has changed, but also whether there is currently an incoming call request. Once an incoming call is detected, the terminal will trigger a random access procedure.

When the terminal is in an RRC_IDLE state, an RRC_INACTIVE state, or an RRC_CONNECTED state, the terminal can also determine, according to the paging message, whether to receive an earthquake and tsunami warning system (ETWS) notification or a commercial mobile alert system (CMAS) notification, if the terminal supports such capability.

As can be seen, the paging message has the following functions: (1) sending an incoming call request to the terminal in an RRC_IDLE state; (2) notifying the terminal in an RRC_IDLE state, in an RRC_INACTIVE state, or in an RRC_CONNECTED state that system information has changed; (3) instructing the terminal to start receiving an ETWS primary notification and/or an ETWS secondary notification; and instructing the terminal to start receiving a CMAS notification.

In addition, before monitoring the paging message, the terminal needs to complete time-frequency synchronization and automatic gain control (AGC) adjustment by using a reference signal (for example, a synchronization signal block (SSB)).

### 2. Paging Cycle, Paging Frame (PF), and Paging Occasion (PO)

The terminal in an RRC_IDLE state or in an RRC_INACTIVE state may use discontinuous reception (DRX) in order to reduce power consumption. A paging procedure supports DRX, and therefore, the paging cycle may also be referred to as a DRX cycle.

A DRX cycle may have at least one PF, and each PF may correspond to at least one PO. A PF may be a radio frame or a system frame. A PO can include multiple physical downlink control channel (PDCCH) monitoring occasions, and can consist of multiple subframes, multiple time slots (also referred to as “slots”), or multiple orthogonal frequency division multiplexing (OFDM) symbols.

In short, the terminal can monitor one PO per paging cycle (or DRX cycle) in order to monitor whether there is paging downlink control information (paging DCI), a paging message, etc. 3. Wake-up signal (WUS)

In some wireless communication networks (such as IoT), the probability that a network pages the terminal is low, and as a result, the terminal does not have to monitor paging DCI at a PO(s) in some DRX cycle(s). Therefore, in order to further reduce power consumption of the terminal, a WUS mechanism is introduced in a standard protocol formulated by the 3^{rd} generation partnership project (3GPP).

If the terminal is in an RRC_IDLE state or an RRC_INACTIVE state, the network device may send a WUS to the terminal before the terminal monitors a PO, and then the terminal may determine, according to an indication of the WUS, whether to monitor a PO corresponding to the WUS, which can prevent the terminal from always monitoring a PO in a paging cycle, thereby reducing power consumption of the terminal.

As can be seen, with the WUS mechanism, it is possible to substantially reduce power consumption of the terminal. However, with continuous evolution of standard protocols formulated by 3GPP and continuous increase in complexity of communication scenarios, to prolong the battery life of the terminal to a duration of several weeks or even several years, 3GPP is currently discussing issues related to introducing a new WUS (for example, a low-power WUS), as well as scenarios of using the new WUS to wake up the terminal in a non-RRC_IDLE state or in a non-RRC_INACTIVE state so as to reduce power consumption. To this end, the problem regarding transmission resource configuration for the new WUS and how the terminal receives the new WUS needs to be solved in a future standard protocol.

Embodiments of the disclosure provide a method and apparatus for determining a resource location, a terminal, and a network device, so as to determine, based on configuration information, a resource location used for monitoring a first wake-up signal (WUS) in a first state, thereby ensuring robustness and stability of system communication while reducing network overhead and power consumption of the terminal.

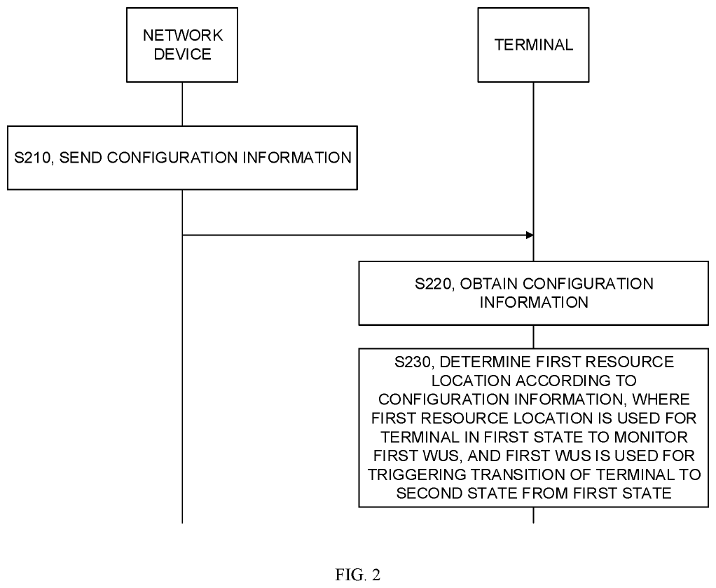

In conjunction with the foregoing elaborations, embodiments of the disclosure provide a method for determining a resource location. As illustrated in FIG. 2, the method includes the following.
S210, a network device sends configuration information.

The configuration information may be used for determining a first resource location, where the first resource location may be used for a terminal in a first state to monitor a first WUS, and the first WUS may be used for triggering transition of the terminal to a second state from the first state.
S220, the terminal obtains the configuration information.
S230, the terminal determines the first resource location according to the configuration information, where the first resource location is used for the terminal in the first state to monitor the first WUS, and the first WUS is used for triggering transition of the terminal to the second state from the first state.

As can be seen, the terminal obtains the configuration information, and determines the first resource location according to the configuration information, where the first resource location is used for the terminal in the first state to monitor the first WUS, and the first WUS is used for triggering transition of the terminal to the second state from the first state. Since the configuration information is used for determining the first resource location, it is possible to determine, based on the configuration information, a resource location used for monitoring the first WUS in the first state, thereby ensuring robustness and stability of system communication while reducing network resource overhead and power consumption of the terminal.

In some embodiments, the first WUS may include a low-power WUS.

In some embodiments, the first state may indicate that the terminal is in a first operating state, and the second state may indicate that the terminal is in a second operating state, where the first operating state is different from the second operating state.

In addition, the terminal in the first operating state (or the first state) may be unable to perform normal communication operations or update related parameters, but can monitor the first WUS. The terminal in the second operating state (or the second state) can perform normal communication operations or update related parameters.

It should be noted that, in a standard protocol formulated by 3GPP, a WUS mechanism is introduced, and a WUS can indicate whether the terminal in an RRC_IDLE state or in an RRC_INACTIVE state needs to monitor a PO corresponding to the WUS. However, with continuous evolution of standard protocols formulated by 3GPP and continuous increase in complexity of communication scenarios, there may be a scenario where wake-up of the terminal in a non-RRC_IDLE state or in a non-RRC_INACTIVE state is needed for reducing power consumption.

To this end, a new WUS mechanism is considered in the disclosure. That is, the first WUS is used to trigger transition of the terminal in the first state to the second state from the first state, so as to ensure that the terminal can transition promptly to the second state from the first state and perform corresponding operations or update related parameters in the second state. In the first state, the terminal does not need to perform corresponding communication operations or update related parameters, and therefore, power consumption can be reduced. In addition, in the second state, the terminal needs to perform related communication operations and transmission of related data, for example, monitor paging DCI, receive a system message, transmit related data, etc. As can be seen, power consumption of the terminal in the second state is higher than power consumption of the terminal in the first state.

In addition, in order to determine a resource location (namely, the first resource location) used for monitoring the first WUS in the first state, in the disclosure, the network device sends the configuration information, and then the terminal determines the first resource location according to the configuration information. As such, it is possible to determine, based on the configuration information, the resource location used for monitoring the first WUS in the first state, thereby ensuring robustness and stability of system communication while reducing network overhead and power consumption of the terminal.

With reference to the above illustration, technical solutions involved in the foregoing method will be elaborated below in embodiments of the disclosure.

Specifically, the first state (or the first operating state) may include a deep sleep state, a power-off state, or a flight mode state. The second state (or the second operating state) may include an RRC idle state, an RRC inactive state, or an RRC connected state.

It should be noted that, if the terminal is in the deep sleep state, the network device may send the first WUS to trigger transition of the terminal to the RRC_IDLE/RRC_INACTIVE/RRC_CONNECT state from the deep sleep state, that is, the terminal determines, according to the first WUS, that the terminal needs to leave the deep sleep mode and enter an active mode. Compared with the RRC_IDLE/RRC INACTIVE/RRC_CONNECT state, power consumption of the terminal is lower in the deep sleep state.

If the terminal is in the power-off state or in the flight mode state, the network device may send the first WUS to trigger transition of the terminal to the RRC_IDLE/RRC INACTIVE/RRC_CONNECT state from the power-off state/the flight mode state, that is, the terminal determines, according to the first WUS, that the terminal needs to be powered on or leave the flight mode state so as to enter an active mode.

In addition, since the terminal is generally unable to receive any signal in the power-off state/the flight mode state, in order to ensure that the first WUS can be monitored by the terminal in the power-off state/the flight mode state, the terminal in the disclosure may include a primary communication module and a secondary communication module. If the terminal is in the power-off state/the flight mode state, the primary communication module of the terminal is in an off-state, while the secondary communication module is in an on-state so as to monitor the first WUS. If the first WUS is monitored by the secondary communication module of the terminal, the terminal enables the primary communication module, that is, the terminal transitions to the RRC_IDLE/RRC_INACTIVE/RRC_CONNECT state from the power-off state/the flight mode state, and performs corresponding communication operations or updates related parameters with the primary communication module, for example, monitors paging DCI, receives a system message, or transmits related data, etc.

In addition, if the terminal is in the deep sleep state, the terminal may include a primary communication module, and monitors the first WUS with the primary communication module. Alternatively, the terminal may include a primary communication module and a secondary communication module, and monitors the first WUS with the secondary communication module, the details thereof are the same as the foregoing elaborations and will not be elaborated again herein.

Specifically, power consumption of the terminal in the first state is lower than power consumption of the terminal in the second state.

It should be noted that, the terminal in the first state (or the first operating state) is generally unable to perform corresponding communication operations (such as monitor paging DCI, receive a system message, transmit related data, etc.) or update related parameters, while the terminal in the second state (or the second operating state) can perform the foregoing operations. Therefore, compared with the second state, power consumption of the terminal is lower in the first state. In order to ensure communication functions of the terminal, in the disclosure, a low-power WUS (namely, the first WUS) is needed to trigger transition of the terminal to the second state from the first state, which can realize state transition by transmitting the first WUS, thereby ensuring robustness and stability of system communication while reducing network overhead and power consumption of the terminal.

Specifically, the configuration information is carried in a system message, or the configuration information is configured by an RRC layer or an upper layer.

It can be understood that, in the disclosure, the resource location used for monitoring the first WUS may be configured by configuration information in a system broadcast message, or the resource location used for monitoring the first WUS may be configured by RRC or an upper layer.

Specifically, the configuration information may include at least one of: paging configuration parameter information, monitoring window length parameter information, first offset information, or wake-up configuration parameter information. The paging configuration parameter information may be used for configuring a PF or a PO. The monitoring window length parameter information may be used for configuring a length of a monitoring window for the first WUS. The first offset information may be used for configuring an offset from a PF or a PO to a starting position of the first resource location. The wake-up configuration parameter information may be used for configuring the first resource location.

It should be noted that, the configuration information in the disclosure may include the paging configuration parameter information. In some embodiments, the paging configuration parameter information may include a higher-layer parameter DownlinkConfigCommonSIB. The higher-layer parameter DownlinkConfigCommonSIB may be used for providing common downlink parameters of a cell. The higher-layer parameter DownlinkConfigCommonSIB may include a higher-layer parameter PCCH-Config. The higher-layer parameter PCCH-Config may be used for configuring a paging procedure. As such, it is possible to determine, based on the paging configuration parameter information, the resource location used for monitoring the first WUS in the first state, thereby ensuring robustness and stability of system communication while reducing network overhead and power consumption of the terminal.

Exemplarily, the higher-layer parameter PCCH-Config includes the following parameters:

| | |
|---|---|
| PCCH-Config ::= | SEQUENCE { |
| defaultPagingCycle | PagingCycle, |
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |

},

| | |
|---|---|
| ns | ENUMERATED {four, two, one}, |

```
    firstPDCCH-MonitoringOccasionOfPO CHOICE {
  sCS15KHZoneT SEQUENCE (SIZE (1..maxPO-perPF)) OF INTEGER (0..139),
```

| | |
|---|---|
| sCS30KHZoneT-SCS15KHZhalfT | SEQUENCE (SIZE (1..maxPO-perPF)) OF |

INTEGER (0..279),

| | |
|---|---|
| sCS60KHZoneT-SCS30KHZhalfT-SCS15KHZquarterT | SEQUENCE (SIZE |

```
(1..maxPO-perPF)) OF INTEGER (0..559),
      sCS120KHZoneT-SCS60KHZhalfT-SCS30KHZquarterT-SCS15KHZoneEighthT
SEQUENCE (SIZE (1..maxPO-perPF)) OF INTEGER (0..1119),
      sCS120KHZhalfT-SCS60KHZquarterT-SCS30KHZoneEighthT-
```

| | |
|---|---|
| SCS15KHZoneSixteenthT | SEQUENCE (SIZE (1..maxPO-perPF)) OF INTEGER (0..2239), |

sCS120KHZquarterT-SCS60KHZoneEighthT-SCS30KHZoneSixteenthT
SEQUENCE (SIZE (1..maxPO-perPF)) OF INTEGER (0..4479),

| | |
|---|---|
| sCS120KHZoneEighthT-SCS60KHZoneSixteenthT | SEQUENCE (SIZE |

(1..maxPO-perPF)) OF INTEGER (0..8959),

| | |
|---|---|
| sCS120KHZoneSixteenthT | SEQUENCE (SIZE (1..maxPO-perPF)) |

```
OF INTEGER (0..17919)
    } OPTIONAL,
    ...,
    [[
    nrofPDCCH-MonitoringOccasionPerSSB-InPO-r16 INTEGER (2..4) OPTIONAL
]]
  }
```

The higher-layer parameter defaultPagingCycle may be used for configuring a default paging cycle (or DRX cycle).

The higher-layer parameter nAndPagingFrameOffset may be used for configuring the total number of PFs and a PF offset in a paging cycle (or DRX cycle). oneT represents that a paging cycle has one PF, halfT represents that a paging cycle has two PFs, and so forth. INTEGER (0 . . . 1) indicates a PF offset between two PFs, and so forth.

The higher-layer parameter ns can be used for configuring the total number of POs corresponding to a PF. For example, one PF may correspond to one PO, two POs, or four POs, etc.

The higher-layer parameter firstPDCCH-MonitoringOccasionOfPO may be used for configuring a location of a starting PDCCH monitoring occasion for each PO corresponding to a PF. One PO consists of multiple consecutive PDCCH monitoring occasions.

In addition, the configuration information in the disclosure may include the monitoring window length parameter information, where the monitoring window length parameter information may be used for configuring the length of the monitoring window for the first WUS. The monitoring window for the first WUS may be understood as a duration for which the terminal can monitor the first WUS in time domain. In addition, the length of the monitoring window for the first WUS may be less than one paging cycle (or one DRX cycle). That is, the monitoring window length parameter information may be used for configuring the length of the monitoring window for the first WUS within one paging cycle (or one DRX cycle).

Furthermore, the configuration information in the disclosure may include the first offset information, where the first offset information may be used for configuring the offset from a PF or a PO to the starting position of the first resource location. It can be understood that, the terminal may firstly determine a PF or PO according to the paging configuration parameter information, and then determine, according to the PF or PO determined and the first offset information, the resource location (namely, the first resource location) used for monitoring the first WUS in the first state.

Moreover, the configuration information in the disclosure may include the wake-up configuration parameter information, where the wake-up configuration parameter information may be used for configuring the first resource location. It can be understood that, the network may send separately configuration information (namely, the wake-up configuration parameter information) used for configuring the first WUS. As such, it is possible to determine, based on the wake-up configuration parameter information, the resource location used for monitoring the first WUS in the first state, thereby ensuring robustness and stability of system communication while reducing network overhead and power consumption of the terminal.

With reference to the foregoing illustrations, the following will describe in detail how to determine the first resource location according to configuration information.

### Manner 1:

Specifically, if the configuration information includes the paging configuration parameter information, the first resource location may be determined according to the configuration information in S230 as follows. The terminal determines a first PF or a first PO according to the paging configuration parameter information and device identity (ID) information of the terminal, and takes the first PF or the first PO as the first resource location.

It should be noted that, the PF or PO used for paging may be determined according to the following formula:

$$( S F N + PF\_offset ) mod T = ( Tdi vN ) * ( UE\_IDmodN )$$

$$i\_s = floor ( UE\_ID / N ) mod Ns$$

The SFN represents a system frame number of the PF.

T represents a paging cycle or a DRX cycle. The value of T may be determined according to the higher-layer parameter defaultPagingCycle. In addition, T=min(Tc, Tue), where Tc represents a specific DRX value (configured by RRC or an upper layer), and Tue represents a default DRX value broadcast in system information.

PF_offset represents an offset used for PF determination. The value of PF_offset may be determined according to the higher-layer parameter nAndPagingFrameOffset.

N represents the total number of PFs in a paging cycle or DRX cycle. The value of N may be determined according to the higher-layer parameter nAndPagingFrameOffset.

i_s represents an index of a PO corresponding to a PF, that is, i_s indicates that the terminal is to monitor an (i_s+1)^{th} PO in the PF.

Ns represents the total number of POs corresponding to a PF. The value of Ns may be determined according to the higher-layer parameter ns.

UE_ID represents the device ID information of the terminal. The value of UE_ID may be determined according to: 5^{th} generation system architecture evolution temporary mobile subscriber identity (5G-S-TMSI) mod 1024, where TMSI represents a temporary mobile subscriber identity of the terminal, and may be used for uniquely differentiating different terminals. If the terminal does not have a TMSI, UE_ID=0 by default.

As can be seen, the paging configuration parameter in the disclosure may include T, PF_offset, N, and/or Ns. In this way, the terminal can determine a PF (such as an SFN of the first PF) or PO (such as i_s of the first PO) according to the paging configuration parameter (such as T, PF_offset, N, and Ns) and the device ID information of the terminal (such as UE_ID), and take the determined PF or PO as the resource location used for monitoring the first WUS, that is, the terminal monitors the first WUS at the determined PF or PO. As such, it is possible to determine, based on the paging configuration parameter, the resource location used for monitoring the first WUS in the first state, thereby ensuring robustness and stability of system communication while reducing network overhead and power consumption of the terminal.

### Manner 2:

Specifically, if the configuration information includes the paging configuration parameter information and the monitoring window length parameter information, the first resource location may be determined according to the configuration information in S230 as follows. The terminal determines a second PF or a second PO according to the paging configuration parameter information and device ID information of the terminal. The terminal determines the starting position of the first resource location according to the second PF or the second PO. The terminal determines the first resource location according to the starting position of the first resource location and the monitoring window length parameter information.

It should be noted that, with reference to manner 1, it can be seen that the terminal may determine a PF (such as an SFN of the second PF) or PO (such as i_s of the second PO) according to the paging configuration parameter (such as T, PF_offset, N, and Ns) and the device ID information (such as UE_ID) of the terminal. Then the terminal may determine the starting position of the first resource location according to the PF or PO determined, so as to obtain a starting time of the resource location used for monitoring the first WUS in time domain. Finally, the terminal may determine the first resource location according to the starting position of the first resource location and the monitoring window length parameter information. As such, it is possible to determine, based on the paging configuration parameter information and the monitoring window length parameter information, the resource location used for monitoring the first WUS in the first state, thereby ensuring robustness and stability of system communication while reducing network overhead and power consumption of the terminal.

The starting position of the first resource location may be one of: a 1^{st} PDCCH monitoring occasion in the second PO, a 1^{st} time slot in the second PO, a 1^{st} OFDM symbol in the second PO, a subframe in which the second PO is located, or a system frame in which the second PF is located.

It should be noted that, the terminal in an RRC_IDLE state or in an RRC_INACTIVE state may use DRX in order to reduce power consumption. A paging cycle (or DRX cycle) may have at least one PF. A PF may correspond to at least one PO. A PF may be a radio frame or a system frame. A PO may include multiple PDCCH monitoring occasions, and can consist of multiple subframes, multiple time slots, or multiple OFDM symbols. In short, the terminal can monitor one PO per paging cycle (or DRX cycle) so as to monitor whether there is paging DCI.

Based on this, the starting position of the first resource location in the disclosure may be the 1^{st} PDCCH monitoring occasion/the last PDCCH monitoring occasion/any PDCCH monitoring occasion in the PO, or may be the 1^{st} time slot/the last time slot/any time slot in the PO, or may be the 1^{st} OFDM symbol/the last OFDM symbol/any OFDM symbol in the PO, or may be a subframe in which the PO is located, or may be a system frame in which the PF is located, and there is no limitation in this regard. In this way, it is possible to realize determination of the first resource location based on the starting position of the first resource location, which ensures robustness and stability of system communication.

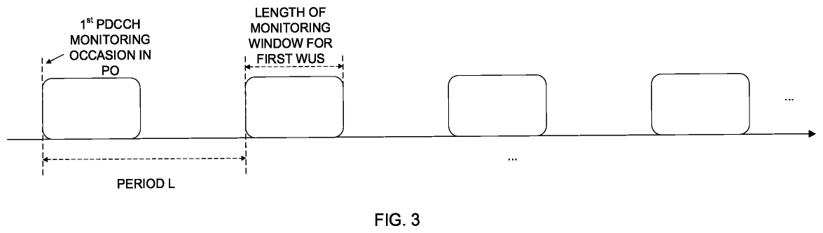

Exemplarily, as illustrated in FIG. 3, the starting position of the first resource location is the 1^{st} PDCCH monitoring occasion in the PO determined by the terminal. The first resource location may include the monitoring window for the first WUS that occurs at period L. The monitoring window for the first WUS has a certain length, where the length may be represented as a resource size of the monitoring window for the first WUS in time domain. Therefore, the terminal monitors the first WUS only in the monitoring window for the first WUS.

### Manner 3:

Specifically, if the configuration information includes the paging configuration parameter information, the monitoring window length parameter information, and the first offset information, the first resource location may be determined according to the configuration information in S230 as follows. The terminal determines a third PF or a third PO according to the paging configuration parameter information and device ID information of the terminal. The terminal determines the starting position of the first resource location according to the first offset information and one of the third PF or the third PO. The terminal determines the first resource location according to the starting position of the first resource location and the monitoring window length parameter information.

It should be noted that, with reference to manner 2, it can be seen that the terminal may determine a PF (such as the SFN of the second PF) or PO (such as i_s of the second PO) according to the paging configuration parameter (such as T, PF_offset, N, and Ns) and the device ID information (such as UE_ID) of the terminal. Then the terminal may determine the starting position of the first resource location according to the PF or PO determined and the first offset information, so as to obtain a start time of the resource location used for monitoring the first WUS in time domain. Finally, the terminal determines the first resource location according to the starting position of the first resource location and the monitoring window length parameter information. As such, it is possible to determine, based on the paging configuration parameter information, the monitoring window length parameter information, and the first offset information, the resource location used for monitoring the first WUS in the first state, thereby ensuring robustness and stability of system communication while reducing network overhead and power consumption of the terminal.

Different from manner 2 above, there is a certain offset (represented by the first offset information) from the determined PO or PF to the starting position of the first resource location. Specifically, the first offset information may be represented as an offset from the starting position of the first resource location to the 1^{st} PDCCH monitoring occasion/the last PDCCH monitoring occasion/any PDCCH monitoring occasion in the determined PO, or may be represented as an offset from the starting position of the first resource location to the 1^{st} time slot/the last time slot/any time slot in the determined PO, or may be represented as an offset from the starting position of the first resource location to the 1^{st} OFDM symbol/the last OFDM symbol/any OFDM symbol in the determined PO, or may be represented as an offset from the starting position of the first resource location to a subframe in which the determined PF is located, or may be represented as an offset from the starting position of the first resource location to a system frame where the determined PO is located, and there is no limitation in this regard.

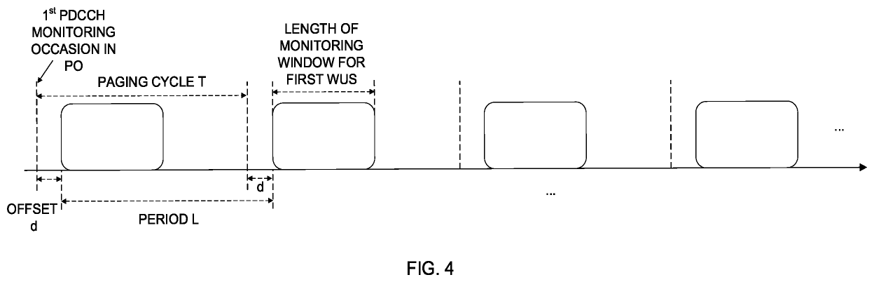

Exemplarily, as illustrated in FIG. 4, the offset from the 1^{st} PDCCH monitoring occasion in the PO determined by the terminal to the starting position of the first resource location is d. The first resource location may include the monitoring window for the first WUS that occurs at period I., there is paging cycle T′ between the POs determined by the terminal, and the terminal monitors the first WUS only in the monitoring window for the first WUS.

### Manner 4:

Specifically, the wake-up configuration parameter information may include at least one of: a first configuration parameter, a second configuration parameter, or a third configuration parameter. The first configuration parameter is used for configuring the starting position of the first resource location. The second configuration parameter is used for configuring the length of the monitoring window for the first WUS. The third configuration parameter is used for configuring a period of the monitoring window for the first WUS.

It should be noted that, with reference to the foregoing elaborations, the network may send separately the wake-up configuration parameter information used for configuring the first resource location. The starting position of the first resource location is configured by the first configuration parameter in the wake-up configuration parameter information, the length of the monitoring window for the first WUS is configured by the second configuration parameter in the wake-up configuration parameter information, and the period of the monitoring window for the first WUS is configured by the third configuration parameter in the wake-up configuration parameter information. As such, it is possible to determine, based on the first configuration parameter, the second configuration parameter, and the third configuration parameter, the resource location for monitoring the first WUS in the first state, thereby ensuring robustness and stability of system communication while reducing network overhead and power consumption of the terminal.

As can be seen, if the configuration information includes the wake-up configuration parameter information, the first resource location may be determined according to the configuration information in S230 as follows. The terminal determines the first resource location according to the wake-up configuration parameter information.

The wake-up configuration parameter information may include the first configuration parameter, the second configuration parameter, or the third configuration parameter. Therefore, the network may send separately the wake-up configuration parameter information so as to realize determination of the resource location used for monitoring the first WUS in the first state, thereby ensuring robustness and stability of system communication while reducing network overhead and power consumption of the terminal.

The solutions in embodiments of the disclosure are introduced mainly from the perspective of method. It can be understood that, in order to implement the foregoing functions, the terminal or the network device includes corresponding hardware structures and/or software modules for executing respective functions. Those of ordinary skill in the art will appreciate that units and algorithmic operations of various examples described in connection with embodiments herein may be implemented by hardware or by a combination of hardware and computer software. Whether these functions are performed by means of hardware or hardware driven by computer software depends on the application and the design constraints of the associated technical solution. Those skilled in the art may use different methods with regard to each particular application to implement the described functionality, but such methods should not be regarded as lying beyond the scope of the disclosure.

In embodiments of the disclosure, division of functional units of the terminal or the network device may be implemented according to the foregoing method examples. For example, functional units may be divided to correspond to respective functions, or two or more functions may be integrated into one processing unit. The integrated unit may be implemented in a form of hardware, or may be implemented in a form of software program module. It should be noted that, the division of units in embodiments of the disclosure is illustrative and is only a division of logical functions, and other manners of division may also available in practice.

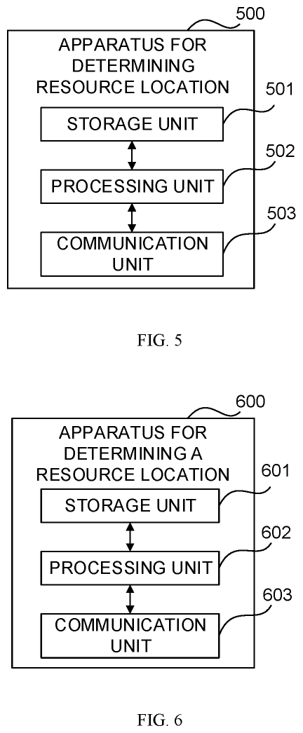

If an integrated unit is adopted, FIG. 5 is a block diagram illustrating functional units of an apparatus for determining a resource location. The apparatus 500 for determining a resource location includes a processing unit 502 and a communication unit 503. The processing unit 502 is configured to control and manage actions of the apparatus 500. For example, the processing unit 502 is configured to support the apparatus 500 to implement the steps performed by the terminal in FIG. 2, as well as other procedures in the technical solutions described in the disclosure. The communication unit 503 is configured to support communication between the apparatus 500 and other devices in a wireless communication system. The apparatus 500 may further include a storage unit 501. The storage unit 501 is configured to store program codes executed by the apparatus 500 and data to be transmitted by the apparatus 500.

It should be noted that, the apparatus 500 may be a chip or a chip module.

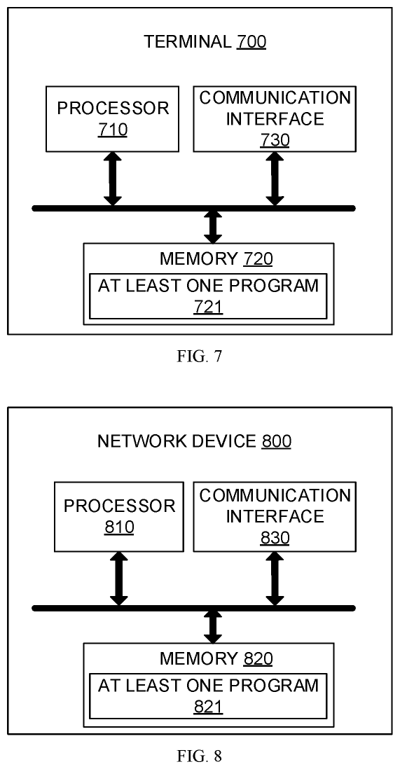

The processing unit 502 may be a processor or a controller and may be, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various exemplary logic blocks, modules, and circuits disclosed in the disclosure can be implemented or executed. The processing unit 502 may also be a combination for implementing computing functions, for example, one or more microprocessors, a combination of DSP and microprocessor, or the like. The communication unit 503 may be a communication interface, a transceiver, a transceiver circuit, or the like, and the storage unit 501 may be a memory. If the processing unit 502 is a processor, the communication unit 503 is a communication interface, and the storage unit 501 is a memory, the apparatus 500 involved in embodiments of the disclosure may be a terminal illustrated in FIG. 7.

In an implementation, the processing unit 502 is configured to perform any step executed by the terminal in the foregoing method embodiments, and when performing data transmission such as sending, the processing unit 502 may optionally invoke the communication unit 503 to complete corresponding operations. Detailed elaborations will be given below.

The processing unit 502 is configured to: obtain configuration information, and determine a first resource location according to the configuration information, where the first resource location is used for the apparatus 500 in a first state to monitor a first WUS, and the first WUS is used for triggering transition of the apparatus 500 to a second state from the first state.

It should be noted that, for the implementation of various operations in the embodiments illustrated in FIG. 5, reference can be made to the elaborations in the method embodiments illustrated in FIG. 2, which will not be described in detail again herein.

As can be seen, the apparatus 500 obtains the configuration information, and determines the first resource location according to the configuration information, where the first resource location is used for the apparatus 500 in the first state to monitor the first WUS, and the first WUS is used for triggering transition of the apparatus 500 to the second state from the first state, which is possible to determine, based on the configuration information, a resource location used for monitoring the first WUS in the first state, thereby ensuring robustness and stability of system communication while reducing network overhead and power consumption of the terminal.

Specifically, the configuration information includes at least one of: paging configuration parameter information, monitoring window length parameter information, first offset information, or wake-up configuration parameter information. The paging configuration parameter information is used for configuring a PF or a PO. The monitoring window length parameter information is used for configuring a length of a monitoring window for the first WUS. The first offset information is for configuring an offset from a PF or PO to a starting position of the first resource location. The wake-up configuration parameter information is used for configuring the first resource location.

Specifically, the configuration information includes the paging configuration parameter information, and in terms of determining the first resource location according to the configuration information, the processing unit 502 is configured to: determine a first PF or a first PO according to the paging configuration parameter and device ID information of a terminal, and take the first PF or the first PO as the first resource location.

Specifically, the configuration information includes the paging configuration parameter information and the monitoring window length parameter information, and in terms of determining the first resource location according to the configuration information, the processing unit 502 is configured to: determine a second PF or a second PO according to the paging configuration parameter information and device ID information of a terminal, determine the starting position of the first resource location according to the second PF or the second PO, and determine the first resource location according to the starting position of the first resource location and the monitoring window length parameter information.

Specifically, the starting position of the first resource location is one of: a 1^{st} PDCCH monitoring occasion in the second PO, a 1^{st} time slot in the second PO, a 1^{st} OFDM symbol in the second PO, a subframe in which the second PO is located, or a system frame in which the second PF is located.

Specifically, the configuration information includes the paging configuration parameter information, the monitoring window length parameter information, and the first offset information, and in terms of determining the first resource location according to the configuration information, the processing unit 502 is configured to: determine a third PF or a third PO according to the paging configuration parameter information and device ID information of a terminal, determine the starting position of the first resource location according to the first offset information and one of the third PF or the third PO, and determine the first resource location according to the starting position of the first resource location and the monitoring window length parameter information.

Specifically, the wake-up configuration parameter information includes at least one of: a first configuration parameter, a second configuration parameter, or a third configuration parameter. The first configuration parameter is used for configuring the starting position of the first resource location. The second configuration parameter is used for configuring the length of the monitoring window for the first WUS. The third configuration parameter is used for configuring a period of the monitoring window for the first WUS.

Specifically, the configuration information includes the wake-up configuration parameter information, and in terms of determining the first resource location according to the configuration information, the processing unit 502 is configured to: determine the first resource location according to the wake-up configuration parameter information.

Specifically, the first state includes a deep sleep state, a power-off state, or a flight mode state, and the second state includes an RRC idle state, an RRC inactive state, or an RRC connected state.

Specifically, power consumption of the apparatus in the first state is lower than power consumption of the apparatus in the second state.

Specifically, the configuration information is carried in a system message, or the configuration information is configured by an RRC layer or an upper layer.

If an integrated unit is adopted, FIG. 6 is a block diagram illustrating functional units of another apparatus for determining a resource location. The apparatus 600 includes a processing unit 602 and a communication unit 603. The processing unit 602 is configured to control and manage actions of the apparatus 600. For example, the processing unit 602 is configured to support the apparatus 600 to implement steps performed by the network device in FIG. 2, as well as other procedures in the technical solutions described in the disclosure. The communication unit 603 is configured to support communication between the apparatus 600 and other devices in a wireless communication system. The apparatus 600 may further include a storage unit 601. The storage unit 601 is configured to store program codes executed by the apparatus 600 and data to be transmitted by the apparatus 600.

It should be noted that, the apparatus 600 may be a chip or a chip module.

The processing unit 602 may be a processor or a controller, and may be, for example, a CPU, a DSP, an ASIC, an FPGA, or other programmable logic devices, transistor logic devices, hardware components, or any combination thereof. Various exemplary logic blocks, modules, and circuits disclosed in the disclosure can be implemented or executed. The processing unit 602 may also be a combination for implementing computing functions, for example, one or more microprocessors, a combination of DSP and microprocessor, or the like. The communication unit 603 may be a communication interface, a transceiver, a transceiver circuit, or the like, and the storage unit 601 may be a memory. If the processing unit 602 is a processor, the communication unit 603 is a communication interface, and the storage unit 601 is a memory, the apparatus 600 involved in embodiments of the disclosure may be a network device illustrated in FIG. 8.

In an implementation, the processing unit 602 is configured to perform any step executed by the network device in the foregoing method embodiments, and when performing data transmission such as sending, the processing unit 602 may optionally invoke the communication unit 603 to complete corresponding operations. Detailed elaborations will be given below.

The processing unit 602 is configured to send configuration information, where the configuration information is used for determining a first resource location, the first resource location is used for a terminal in a first state to monitor a first WUS, and the first WUS is used for triggering transition of the terminal to a second state from the first state.

It should be noted that, for the implementation of various operations in the embodiments illustrated in FIG. 6, reference can be made to the elaborations in the method embodiments illustrated in FIG. 2, which will not be described in detail again herein.

As can be seen, the apparatus 600 sends the configuration information, where the configuration information is used for determining the first resource location, the first resource location is used for the terminal in the first state to monitor the first WUS, and the first WUS is used for triggering transition of the terminal to the second state from the first state. As such, it is possible to determine, based on the configuration information, a resource location used for monitoring the first WUS in the first state, thereby ensuring robustness and stability of system communication while reducing network overhead and power consumption of the terminal.

Specifically, the configuration information includes at least one of: paging configuration parameter information, monitoring window length parameter information, first offset information, or wake-up configuration parameter information. The paging configuration parameter information is used for configuring a PF or a PO. The monitoring window length parameter information is used for configuring a length of a monitoring window for the first WUS. The first offset information is for configuring an offset from a PF or PO to a starting position of the first resource location. The wake-up configuration parameter information is used for configuring the first resource location.

Specifically, the wake-up configuration parameter information includes at least one of: a first configuration parameter, a second configuration parameter, or a third configuration parameter. The first configuration parameter is used for configuring the starting position of the first resource location. The second configuration parameter is used for configuring the length of the monitoring window for the first WUS. The third configuration parameter is used for configuring a period of the monitoring window for the first WUS.

Specifically, the first state includes a deep sleep state, a power-off state, or a flight mode state, and the second state includes an RRC idle state, an RRC inactive state, or an RRC connected state.

Specifically, the configuration information is carried in a system message, or the configuration information is configured by an RRC layer or an upper layer.

Referring to FIG. 7, FIG. 7 is a schematic structural diagram of a terminal provided in embodiments of the disclosure. The terminal 700 includes a processor 710, a memory 720, a communication interface 730, and a communication bus connecting the processor 710, the memory 720, and the communication interface 730.

The memory 720 includes, but is not limited to, a random access memory (RAM), a read-only memory (ROM), an erasable programmable ROM (EPROM), or a compact disc ROM (CD-ROM). The memory 720 is configured to store program codes executed by the terminal 700 and data to be transmitted by the terminal 700.

The communication interface 730 is configured to receive and transmit data.

The processor 710 may be one or more CPUs. If the processor 710 is a CPU, the CPU may be a single-core CPU or a multi-core CPU.

The processor 710 of the terminal 700 is configured to read at least one program 721 stored in the memory 720, to perform the following operations: obtaining configuration information, and determining a first resource location according to the configuration information, where the first resource location is used for the terminal 700 in a first state to monitor a first WUS, and the first WUS is used for triggering transition of the terminal 700 to a second state from the first state.

It should be noted that, for the implementation of various operations, reference can be made to the corresponding elaborations of the method embodiments illustrated in FIG. 2. The terminal 700 may be configured to perform the method at the terminal side of the foregoing method embodiments of the disclosure, which is not described again herein.

Referring to FIG. 8, FIG. 8 is a schematic structural diagram of a network device provided in embodiments of the disclosure. The network device 800 includes a processor 810, a memory 820, a communication interface 830, and a communication bus connecting the processor 810, the memory 820, and the communication interface 830.

The memory 820 includes, but is not limited to, a RAM, a ROM, an EPROM, or a CD-ROM, and is configured to store related instructions and data.

The communication interface 830 is configured to receive and transmit data.

The processor 810 may be one or more CPUs. If the processor 810 is a CPU, the CPU may be a single-core CPU or a multi-core CPU.

The processor 810 of the network device 800 is configured to read at least one program 821 stored in the memory 820, to perform the following operations: sending configuration information, where the configuration information is used for determining a first resource location, the first resource location is used for a terminal in a first state to monitor a first WUS, and the first WUS is used for triggering transition of the terminal to a second state from the first state.

It should be noted that, for the implementation of various operations, reference can be made to the corresponding elaborations of the method embodiments illustrated in FIG. 2. The network device 800 may be configured to perform the method at the network-device side in the foregoing method embodiments of the disclosure, which is not described again herein.

Embodiments of the disclosure further provide a computer-readable storage medium. The computer-readable storage medium is configured to store computer programs for electronic data interchange (EDI). The computer programs are operable with a computer to perform some or all of the steps of the terminal or the network device described in the foregoing method embodiments.

Embodiments of the disclosure further provide a computer program product. The computer program product includes computer programs. The computer programs are operable with a computer to perform some or all of the steps of the terminal or the network device described in the foregoing method embodiments. The computer program product may be a software installation package.

It is to be noted that, for the sake of brevity, the foregoing embodiments are described as a series of action combinations. However, it will be appreciated by those skilled in the art that the disclosure is not limited to the sequence of actions described. According to embodiments of the disclosure, some steps may be performed in other orders or simultaneously. In addition, it will be appreciated by those skilled in the art that the embodiments described in the specification are preferable embodiments, and the actions, steps, modules, or units involved are not necessarily essential to the disclosure.

In the foregoing embodiments, the elaboration of each embodiment has its own emphasis. For the parts not described in detail in one embodiment, reference may be made to related elaborations in other embodiments.

Those skilled in the art should understand that some or all of the functions of the methods, steps, or related modules/units described in embodiments of the disclosure may be implemented through software, hardware, firmware, or any other combination thereof. When implemented by software, all or some of the functions may be implemented in the form of a computer program product, or may be implemented by a processor executing computer program instructions. The computer program product includes one or more computer program instructions, where the computer program program instruction may be consist of corresponding software modules. The software module may be stored in a RAM, a flash memory, a ROM, an EPROM, an electrically EPROM (EEPROM), a register, a hard disk, a mobile hard disk, a CD-ROM, or any other form of storage medium well known in the art. The computer program instruction may be stored in a computer-readable storage medium, or transmitted from one computer-readable storage medium to another computer-readable storage medium. For example, the computer program instruction may be transmitted from one website, computer, server, or data center to another website, computer, server, or data center in a wired manner or in a wireless manner. The computer-readable storage medium may be any computer accessible usable-medium or a data storage device such as a server, a data center, or the like which integrates one or more usable media. The usable medium can be a magnetic medium (such as a soft disc, a hard disc, or a magnetic tape), an optical medium, or a semiconductor medium (such as a solid state disk (SSD)), etc.

Each module/unit in various devices or products described in the foregoing embodiments may be a software module/unit or a hardware module/unit, or some may be a software module/unit and the rest may be a hardware module/unit. For example, with regard to various devices or products applied to or integrated into a chip, various modules/units included therein may all be realized by means of hardware such as a circuit; or at least some of the modules/units may be realized by means of a software program run on a processor integrated in the chip, and the rest (if any) modules/units may be implemented by means of hardware such as a circuit. The same also applies to various devices or products applied to or integrated into a chip module or various devices or products applied to or integrated into a terminal.

The objectives, technical solutions, and advantages of embodiments of the disclosure are described in detail in the foregoing implementations. It should be understood that, the foregoing elaborations are merely some implementations of the embodiments of the disclosure, but are not intended to limit the protection scope of the embodiments of the disclosure. Any modifications, equivalent replacements, improvements, and the like made based on the technical solutions of the embodiments of the disclosure shall all fall within the protection scope of the embodiments of the disclosure.

I/We claim:

1. A method for determining a resource location, comprising:
obtaining configuration information; and
determining a first resource location according to the configuration information, wherein the first resource location is used for a terminal in a first state to monitor a first wake-up signal (WUS), and the first WUS is used for triggering transition of the terminal to a second state from the first state.

2. The method of claim 1, wherein the configuration information comprises at least one of: paging configuration parameter information, monitoring window length parameter information, first offset information, or wake-up configuration parameter information, wherein the paging configuration parameter information is used for configuring a paging frame (PF) or a paging occasion (PO);
the monitoring window length parameter information is used for configuring a length of a monitoring window for the first WUS;
the first offset information is used for configuring an offset from a PF or a PO to a starting position of the first resource location;
the wake-up configuration parameter information is used for configuring the first resource location.

3. The method of claim 2, wherein in response to the configuration information comprising the paging configuration parameter information, determining the first resource location according to the configuration information comprises:
determining a first PF or a first PO according to the paging configuration parameter information and device identity (ID) information of the terminal, and taking the first PF or the first PO as the first resource location.

4. The method of claim 2, wherein in response to the configuration information comprising the paging configuration parameter information and the monitoring window length parameter information, determining the first resource location according to the configuration information comprises:
determining a second PF or a second PO according to the paging configuration parameter information and device ID information of the terminal;
determining the starting position of the first resource location according to the second PF or the second PO: and
determining the first resource location according to the starting position of the first resource location and the monitoring window length parameter information.

5. The method of claim 4, wherein the starting position of the first resource location is one of: a 1^{st} physical downlink control channel (PDCCH) monitoring occasion in the second PO, a 1^{st} time slot in the second PO, a 1^{st} orthogonal frequency division multiplexing (OFDM) symbol in the second PO, a subframe in which the second PO is located, or a system frame in which the second PF is located.

6. The method of claim 2, wherein in response to the configuration information comprising the paging configuration parameter information, the monitoring window length parameter information, and the first offset information, determining the first resource location according to the configuration information comprises:
determining a third PF or a third PO according to the paging configuration parameter information and device ID information of the terminal;
determining the starting position of the first resource location according to the first offset information and one of the third PF or the third PO: and
determining the first resource location according to the starting position of the first resource location and the monitoring window length parameter information.

7. The method of claim 2, wherein the wake-up configuration parameter information comprises at least one of: a first configuration parameter, a second configuration parameter, or a third configuration parameter, wherein
the first configuration parameter is used for configuring the starting position of the first resource location;
the second configuration parameter is used for configuring the length of the monitoring window for the first WUS;
the third configuration parameter is used for configuring a period of the monitoring window for the first WUS.

8. The method of claim 2, wherein in response to the configuration information comprising the wake-up configuration parameter information, determining the first resource location according to the configuration information comprises:
determining, by the terminal, the first resource location according to the wake-up configuration parameter information.

9. The method of any of claim 1, wherein
the first state comprises a deep sleep state, a power-off state, or a flight mode state;
the second state comprises a radio resource control (RRC) idle state, an RRC inactive state, or an RRC connected state.

10. The method of any of claim 1, wherein power consumption of the terminal in the first state is lower than power consumption of the terminal in the second state.

11. The method of claim 1, wherein the configuration information is carried in a system message, or the configuration information is configured by an RRC layer or an upper layer.

12-16. (canceled)

17. A terminal, comprising a processor, a memory, and a communication interface, wherein the memory stores at least one program which, when executed by the processor, are operable with the processor to:
obtain configuration information through the communication interface; and
determine a first resource location according to the configuration information, wherein the first resource location is used for the apparatus in a first state to monitor a first wake-up signal (WUS), and the first WUS is used for triggering transition of the apparatus to a second state from the first state.

18. The terminal of claim 17, wherein the configuration information comprises at least one of: paging configuration parameter information, monitoring window length parameter information, first offset information, or wake-up configuration parameter information, wherein
the paging configuration parameter information is used for configuring a paging frame (PF) or a paging occasion (PO);
the monitoring window length parameter information is used for configuring a length of a monitoring window for the first WUS;
the first offset information is used for configuring an offset from a PF or a PO to a starting position of the first resource location;
the wake-up configuration parameter information is used for configuring the first resource location.

19. The terminal of claim 18, wherein the configuration information comprises the paging configuration parameter information, and the processor configured to determine the first resource location according to the configuration information is configured to:
determine a first PF or a first PO according to the paging configuration parameter and device identity (ID) information of a terminal, and take the first PF or the first PO as the first resource location.

20. The terminal of claim 18, wherein the configuration information comprises the paging configuration parameter information and the monitoring window length parameter information, and the processing unit configured to determine the first resource location according to the configuration information is configured to:
determine a second PF or a second PO according to the paging configuration parameter information and device ID information of a terminal;
determine the starting position of the first resource location according to the second PF or the second PO: and
determine the first resource location according to the starting position of the first resource location and the monitoring window length parameter information.

21. The terminal of claim 20, wherein the starting position of the first resource location is one of: a 1^{st} physical downlink control channel (PDCCH) monitoring occasion in the second PO, a 1^{st} time slot in the second PO, a 1^{st} orthogonal frequency division multiplexing (OFDM) symbol in the second PO, a subframe in which the second PO is located, or a system frame in which the second PF is located.

22. The terminal of claim 18, wherein the configuration information comprises the paging configuration parameter information, the monitoring window length parameter information, and the first offset information, and the processor configured to determine the first resource location according to the configuration information is configured to:
determine a third PF or a third PO according to the paging configuration parameter information and device ID information of a terminal;
determine the starting position of the first resource location according to the first offset information and one of the third PF or the third PO; and
determine the first resource location according to the starting position of the first resource location and the monitoring window length parameter information.

23. The terminal of claim 18, wherein the wake-up configuration parameter information comprises at least one of: a first configuration parameter, a second configuration parameter, or a third configuration parameter, wherein
the first configuration parameter is used for configuring the starting position of the first resource location;
the second configuration parameter is used for configuring the length of the monitoring window for the first WUS;
the third configuration parameter is used for configuring a period of the monitoring window for the first WUS.

24. The terminal of claim 18, wherein the configuration information comprises the wake-up configuration parameter information, and the processing unit configured to determine the first resource location according to the configuration information is configured to:
determining the first resource location according to the wake-up configuration parameter information.

25-34. (canceled)

35. A non-transitory computer-readable storage medium configured to store computer programs for electronic data interchange (EDI), wherein the computer programs are operable with a computer to perform the following:
obtaining configuration information; and
determining a first resource location according to the configuration information, wherein the first resource location is used for a terminal in a first state to monitor a first wake-up signal (WUS), and the first WUS is used for triggering transition of the terminal to a second state from the first state.

36. (canceled)
